(19) United States
(12) Patent Application Publication
(10) Pub. No.: US 2006/0129766 A1
(43) Pub. Date: Jun. 15, 2006

(54) Method and apparatus for preloading caches

(76) Inventors: Simon Hugh Cassia, Petersfield (GB); Keith Charles Day, Basingstoke (GB); Simon David Wood, Bracknell (GB)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/524,504

(22) PCT Filed: Aug. 6, 2003
(86) PCT No.: PCT/GB03/03426

§ 371 Date: Oct. 28, 2005

(51) Int. Cl. G06F 13/00

(52) U.S. Cl. 711/137

(57) ABSTRACT

A method (400) of preloading data on a cache (210) in a local machine (235). The cache (210) is operably coupled to a data store (130), in a remote host machine (240). The method includes the steps of determining a user behaviour profile for the local machine (235); retrieving data relating to the user behaviour profile from the data store (130); and preloading the retrieved data in the cache (210), such that the data is made available to the cache user when desired. A local machine, a host machine, a cache, a communication system and preloading functions are also described. In this manner, data within the cache is maintained and replaced in a substantially optimal manner, and configured to be available to a cache user when it is predicted that the user wishes to access the data.

### FIELD OF THE INVENTION

This invention relates to a mechanism for preloading caches. The invention is applicable to, but not limited to, preloading of caches using knowledge or prediction of the cache user's behaviour.

### BACKGROUND OF THE INVENTION

Present day communication systems, both wireless and wire-line, have a requirement to transfer data between communication units. Data, in this context, includes many forms of communication such as speech, video, signalling, WEB pages, etc. Such data communication needs to be effectively and efficiently provided for, in order to optimise use of limited communication resources.

In the field of this invention it is known that an excessive amount of data traffic routed over a core portion of a data network may lead to a data overload in the network. This may lead to an undesirable, excessive consumption of the communication resource, for example bandwidth in a wireless network. To avoid such overload problems, many caching techniques have been introduced to manage the data traffic on a time basis.

It is known that caching techniques have been used for many other reasons, for example, to reduce access time, to make data readily available if there is a potential that a communications. network may go down.

An example of a cache, which may be considered as a local storage element in a distributed communication or computing system, includes network file systems. In the context of network file systems, data is retrieved from a file storage system (e.g. a disk) and can be stored in a cache on the computer that is requesting the data.

A further example of cache usage is a database system, where data records retrieved from a host machine are stored in a local machine's cache. As such, many computer systems keep a local copy (or cache) of machine-readable information, the master copy of which is stored on a host system.

FIG. 1 illustrates a known data communication system 100 that employs the use of a cache 110 to store data locally. A local information processing device 135, such as a personal computer, a personal digital assistant or wireless access protocol (WAP) enabled cellular phone, includes a communication portion 115, operably coupled to the cache 110. The device 135 also includes application software 105 that cooperates with the cache 110 to enable the device 135 to run application software using data stored in, or accessible by, the cache 110. A primary use of the cache 110 is effectively as a localised data store for the local information-processing device 135.

The communication portion 115 is used to connect the cache to remote information system 140, accessible over a communication network 155. In this regard, as well as for many other applications, caches are often used to reduce the amount of data that is transferred over the communication network 155. The amount of data transfer is reduced if the data can be stored in the cache 110. This arrangement avoids the need for data to be transferred to the local information-processing device 135, from a data store 130 in a remote information system 140, over the communication network 155 each time a software application is run.

Furthermore, in general, caches provide a consequent benefit to system performance, as if the data needed by the local information-processing device 135 is already in the cache 110 then the cached data can be processed immediately. This provides a significant time saving when compared to transferring large amounts of data over the communication network 155. In addition, caches improve the communication network's reliability, because if the communication network fails then:
(i) The data in the cache 110 is still available, allowing the local information-processing device 135 to continue its functions, to the extent possible given the extent of the data in the cache 110; and
(ii) The application in the local information-processing device 105 can create new items or modify existing items in the cache, which can then be used to update the remote information system 140 when the communications network is restored.

Caches are also known to have a self-managing capacity function, so that once the cache approaches being full it discards some of the data that it is holding. A number of algorithms exist for this function: a common one is to delete the data that was least recently accessed. In this manner, necessary (and frequently accessed data) is not deleted. Furthermore, the amount of unnecessary information maintained in the cache is minimised. In this context, unnecessary information may be viewed as information that is rarely, if ever, requested by the user.

It is also important that relevant information is downloaded to the cache. Downloading unnecessary information reduces the effective use of the communications channel between the cache and the original data source. Not only does this incur unnecessary communication costs, it utilises the data retrieval resource in both the host and cache.

Most caches are not filled with information until the user requests it, at which point a copy of the information is retrieved and saved in the cache. The information is often stored in the cache in case the user should need the same information again. An example of this type of cache operation is a browser that requests web pages from a remote web server. Once the web page is retrieved, it is stored on the local machine. If the user re-requests the page then (provided it is still valid) the web browser displays the cached version of the page, rather than retrieving it once more from the remote web server.

However, this approach to caching suffers from the drawback that it is only after the user has requested the information that it is retrieved and saved in the cache. In this regard, if the purpose of the particular caching operation is to speed up information access, then the first access will still be slow. Alternatively, if the purpose of the particular caching operation is to make the information available when the original data store is not accessible, then it is only data that has already been downloaded that is available in the cache.

Hence, it is known that some caches are ‘preloaded’ with data so that the data is already available if the user needs it. Two examples of cache preloading are:
(i) Disk file systems, where files of information are stored on a disk in a series of blocks, each block holding only part of a file's information. Many disk file systems assume that users will request an entire file and so retrieve and store all the blocks that comprise the file into the cache before they are specifically requested by the file retrieval management system.
(ii) Furthermore, Web servers are known to cache identified web pages in network servers closer to a recognised requesting party. In this manner, data is preloaded onto a cache in a machine that is closer to the user than the original source of the data, to reduce an amount of communications traffic in the data transfer as well as speeding up access to the cached data. The organisation responsible for the Web servers often downloads a page or set of pages to load onto the caching ‘servers’ based, for example, on the frequency that pages are requested from that server.

However, the inventors of the present invention have recognised inefficiencies and limitations in the operation and use of such preloaded caches. In particular, the methods are not suitable in the case where an individual user requests the information across a communications network that has costs or other limitations associated with using that resource.

In a first example, a lot of unnecessary information (i.e. information that is never requested by a user) may be preloaded onto the cache. If the communications system between the data store and cache has performance limitations or is costly to use, then the user may also incur unnecessary costs or suffer unnecessary performance degradation whilst loading unnecessary data into the cache.

In the second example, the system relies on a statistical prediction of the pages that will be requested by many hundreds or even thousands of users. In this case, it is cost effective to load many pages on the server, as the gains from having some of the pages read many times over outweighs the losses of having some pages that are hardly read at all. If being accessed by a single user then these systems are no longer effective, as they are not able to predict with any certainty what information a single user might request in the future.

Within unrelated fields, such as wireless cellular communications, user-behaviour based concepts are known. One example is where a functionality of a mobile cellular phone is modified based on user-profiles (user behaviour). In this regard, a user may be provided with preferred hand-over options, or enhanced handset features, based on these user profiles, say when entering a particular location, or following an estimated travel itinerary. These profile-based features are always downloaded and stored in a ‘memory element’ of the mobile cellular phone, a substantial amount of time before they are used. Notably, such approaches are not only unrelated to cache functions as herein described,.but are focused on the operational capabilities of the device, to effectively re-configure mobile cellular phone's operation.

Thus, there exists a need to provide an improved mechanism for preloading data objects to a cache, wherein the aforementioned problems are substantially alleviated.

### STATEMENT OF INVENTION

In accordance with a first aspect of the present invention, there is provided a method of preloading data on a cache in a local machine, as claimed in claim 1.

In accordance with a second aspect of the present invention, there is provided a cache, as claimed in claim 27.

In accordance with a third aspect of the present invention, there is provided a local machine, as claimed in claim 28.

In accordance with a fourth aspect of the present invention, there is provided a local machine, as claimed in claim 29.

In accordance with a fifth aspect of the present invention, there is provided a host machine, as claimed in claim 31.

In accordance with a sixth aspect of the present invention, there is provided a host machine, as claimed in claim 32.

In accordance with a seventh aspect of the present invention, there is provided a communication system, as claimed in claim 33.

In accordance with an eighth aspect of the present invention, there is provided a storage medium, as claimed in claim 34.

Further aspects of the present invention are as claimed in the dependent claims.

The preferred embodiments of the present invention. provide a mechanism for preloading data on a cache based on a determined user behaviour profile, such that the data is made available to the cache user when the user desires.

In this manner, data within the cache is maintained in a substantially optimal state, and configured to be available to a cache user when it is predicted that the user wishes to access the data. Thus, selected items of data are cached for predicted retrieval by a cache user on an predicted demand basis, to avoid the cache memory problems and delays in downloading or preloading data to caches in known cache operations.

### BRIEF DESCRIPTION OF THE DRAWINGS

FIG. 1 illustrates a known data communication system, whereby data is transferred from a host machine to a cache residing in a local machine.

Exemplary embodiments of the present invention will now be described, with reference to the accompanying drawings, in which:

FIG. 2 illustrates a functional block diagram of a data communication system, whereby data is transferred from a host machine and preloaded on a cache in a local machine, in accordance with a preferred embodiment of the present invention;

FIG. 3 illustrates a preferred timing arrangement for effecting the preload operation, in accordance with the preferred embodiment of the present invention; and

FIG. 4 is a flowchart illustrating a method of preloading, in accordance with the preferred embodiment of the present invention.

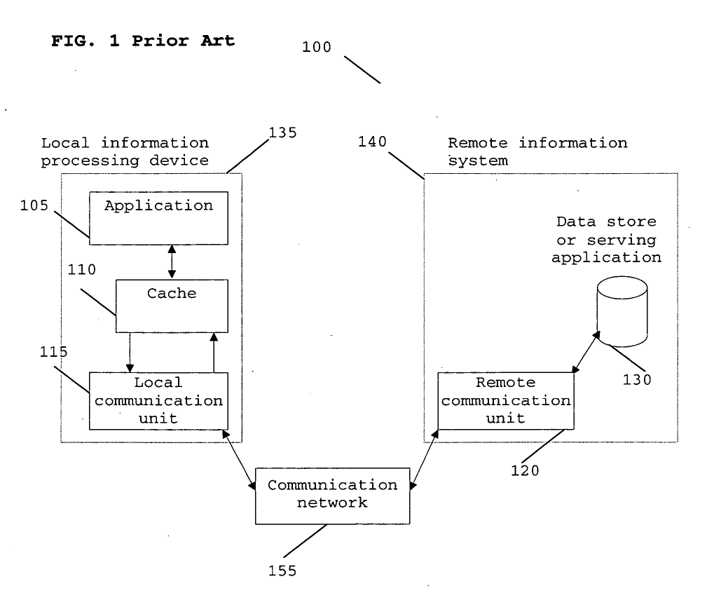

### DESCRIPTION OF PREFERRED EMBODIMENTS

The inventive concepts of the present invention detail, at least, a general approach and a number of specific techniques for efficiently preloading caches with data. In the context of the present invention, the term “user” means either a human user or a computer system, and the term “data” refers to any machine-readable information, including computer programs. Furthermore, in the context of the present invention, the term “local” as applied to data transferred to a local cache or local machine, refers to any element that is closer to the user than the original source of the data.

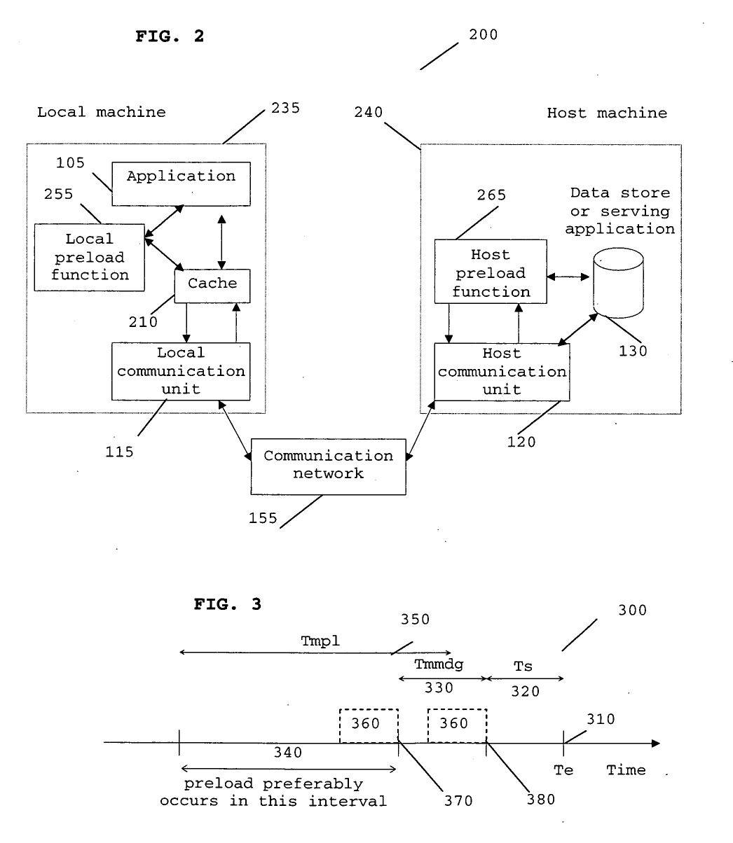

Referring next to FIG. 2, a functional block diagram 200 of a data communication system is illustrated, in accordance with a preferred embodiment of the present invention. Data is transferred between a remote information system (or machine) 240 and a local machine 235, via a communication network 155. An application 105 runs on the local machine 235 and uses data from a data store 130 located on the host machine 240. The local machine 235 and the host machine 240 are connected through one or more communication networks 155 through respective (transceiver) communications units 115, 120 located in each machine, as known in the art. The local machine 235 has a cache 210 that stores selected local copies of data that resides in the data store 130 in the host machine 240.

The preferred embodiment of the present invention is described with reference to a wireless communication network, for example one where personal digital assistants (PDAs) communicate over a GPRS wireless network to an information database. However, it is within the contemplation of the invention that the inventive concepts described herein can be applied to any data communication network—wireless or wireline.

Notably, in accordance with the preferred embodiment of the present invention, a local preload function 255 has been incorporated into the local machine 235, and operably coupled to both the cache 210 and the application 105. Furthermore, a host preload function 265 has been preferably incorporated into the host machine 240, and operably coupled to both the data store 130 and the host transceiver communication unit 120. Generally, in the preferred embodiment, one or both of the preload functions 255, 265 use information (user profile or user behaviour) that they know or can deduce about a user of the cache (210)/local machine (235) to predict what data the user is likely to need. Furthermore, the preload functions 255, 265 preferably determine at what time the user is likely to need the data. In this regard, one or both of the respective preload functions 255, 265 is/are configured to ensure that the cache 210 has the requisite data, predicted to be required by the cache user, when the user so desires it.

Thus, the intelligence to initiate a preload operation is located at the host machine, at the local machine, or at both. Generally, it is advantageous to have the preload intelligence on the machine that has most knowledge of the user's behaviour, i.e. the local machine 235 of FIG. 2. However, if both machines have knowledge of the user's behaviour then it is envisaged that beneficially the machines synchronise their user profile knowledge to build up the best picture possible of the user's need for selected data items. The machines may also schedule preload operations as appropriate.

In a first enhanced embodiment of the present invention, a mechanism to enable the respective preload functions 255, 265 decide what-data is to be preloaded to the cache 210 is described. It is envisaged that many pieces of knowledge about a user may be used to predict what data to preload into the cache 210. Table 1 provides a non-exhaustive set of examples.

TABLE 1

| Knowledge | |
|---|---|
| Item type | Example of Use |
| Meeting | If a sales meeting is to be held at a certain |
| schedule/ | date and time, preload all relevant data for |
| diary | that meeting (customer name, address, maps of |
| | the location, prior business details, etc.). |
| Tasks | If a user must carry out a specific task at |
| | a set time (e.g. stock check) then preload |
| | existing stock details and the stock |
| | checking application. |
| Personal | If a user has an interest in a sports team, |
| Interests | stock market investment, industry sector, |
| | etc., then preload news items related to |
| | that interest so the user can view then at |
| | his/her leisure. |
| Routine | If a user is determined as exhibiting a |
| behaviour | predictable behaviour, e.g. every Friday he |
| | downloads the latest sales forecasts to |
| | prepare a report, preload the sales forecast |
| | at an appropriate time each Friday. |
| Predictable | If the user carries out a set of linked |
| behaviour | tasks, such as filling in a parcel delivery |
| | multi-page report form that uses drop-down |
| | boxes, schedule a preload of the drop-down |
| | box contents for all pages as soon as the |
| | user enters the first page. |
| Foreseeable | If the user carries out task-based |
| behaviour | activities (such as a field service engineer |
| | repairing domestic appliances) then, if the |
| | engineer has a job to repair a washing |
| | machine, preload the parts list for that |
| | washing machine so the list is available |
| | when the engineer needs to record which |
| | parts were replaced. |

Those skilled in the art will realise that known heuristic and artificial intelligence techniques can also

be used to predict the user's future behaviour based, for example, on previous behaviour, and preload data into the cache based on these predictions. Such techniques are known to be complex, and are not described further here.

A preferred example application of the inventive concepts of the present invention is in a wireless domain. Wireless communication systems, where a communication link is dependent upon the surrounding (free space) propagation conditions, the proximity of suitable transmitter/receiver sites and the availability of free bandwidth on the link, are known to be unreliable. Hence, the inventors of the present invention have recognised the need to carefully control the data types, the amount of data and the timing of cache preloading operations in such situations. Such preloading processes need to ensure the preloading process is complete in advance of the data being accessed, in case the local machine 235 were to become disconnected from the communication network for any length of time (for example if it is a wireless device and moves into an area with no radio coverage).

Therefore, in a second enhanced embodiment of the present invention, a mechanism to enable the respective preload functions 255, 265 decide when data is to be preloaded to the cache 210 is described.

Once one of the respective preload functions 255, 265 of FIG. 2 decides that a user may need a specific data item, for example a data item in Table 1, and then it must decide when to load it into the cache 210.

The inventors of the present invention have both recognised and appreciated the criticality of the timing of preload operations. For example, data should not be loaded a substantial time before it is (predicted to be) needed by the cache user. In this context, the user's profile may change in the interim period between the cache being preloaded and the cache user needing the information. Thus, the user may no longer need the cached data. Alternatively, if the data is preloaded from the host machine 240, the data may have been updated in the host machine 240 during this interim period. Thus, the updated data will also need to be preloaded into the cache 210.

If the data is preloaded particularly early, or if the cache dynamics are rapidly changing to optimise its use in accordance with the preferred embodiment of the present invention, the cache 210 will subsequently receive other data items. Hence, a previously preloaded data item may be discarded before the cache user has read it. In a similar manner, the data item may cause the cache 210 to be filled, thereby initiating other ‘to-be-read’ items to be discarded.

Similarly, the inventors have appreciated that the data must not be preloaded too close to the time it is (predicted to be) needed by the cache user. In this regard, it is important to predict, with as much accuracy as possible, when the cache user will need the data. Factors that are preferably considered by the respective preload functions 255, 265 when predicting the time for preloading includes whether the communications network 155 is, or is likely to be, unreliable or busy. In this case, the respective preload functions 255, 265 should factor into the download time the fact that the communications network 155 may not be available when a preload is ideally performed. Furthermore, consideration that the communications network 155 may not be available again until after the time the data is required by the using application 105 needs to be made.

In a typical data communication environment, such as a packet data wireless network, the time allotted for a preloading operation will depend upon a number of factors, for example including, but not limited to, any of the following:
(i) The available bandwidth of the communication network,
(ii) The loading on the communication-channel,
(iii) The size of the block of data to be transmitted to the cache, and
(iv) An amount of processing required to retrieve the data identified from the data store 130.

Hence, referring now to FIG. 3, a preferred preload timing scheme 300 is described. Before beginning the process, a number of timing parameters are determined, based on the factors, for example preload time, network availability, etc., that are known to affect the preload operation. A first timing calculation performed by the preload functions 255, 265 is a determination of a Minimum Message Delivery Guarantee Time Tmmdg 330. A second timing calculation performed is a determination of the Maximum Preload Lead Time Tmpl 350.

Tmmdg 330 is a margin selected to allow for the case when the communications network 155 may not be available when the preload begins, for example due to wireless coverage, congestion, failure or any other reason.

It is envisaged that Tmmdg 330 will be the same for all knowledge item types. However, this need not be the case if a priority rating is also applied to particular data items, dependent upon, say the time of day. One example of this would follow from determining that news items are of particular importance to the cache user first thing on a morning. In this regard, a higher priority rating, and therefore a larger Tmmdg 330 margin, will ensure that current news items are preloaded into the cache at the beginning of a working day. In this manner, the user habits for news items have been appreciated by the preload functions 255, 265, and a determination has been made that news items are more important to the user at the beginning of the day, rather than at the end.

The Tmpl timing parameter 350 is a timing parameter determined by the preload functions 255, 265 as the maximum duration, before a predicted event (Te) 310, when the preload operation can be started. The Tmpl timing parameter 350 is selected to prevent unnecessary information being preloaded if the event was to subsequently change. Preferably, the Tmpl timing parameter 350 is configured to be different for each knowledge item type.

It is envisaged that the values of these timing parameters 330, 350, as well as a safety margin timing parameter Ts 320 described later, can be selected based on theoretical studies of the network behaviour. Such studies may result from simulating or otherwise modelling the network behaviour, by monitoring the network behaviour over time and/or estimating the timing values or by trial and error in each particular implementation. It is also envisaged that the timing parameters 320, 330, 350 may be fixed once set, or can be dynamically or continuously updated in response to changes in the cache or local machine operational environment.

A preferred method for achieving a dynamic or continuous updating of the timing parameters 330, 350 is to first initialise Tmmdg 330 and Tmpl 350 with two threshold values. The threshold values are selected using the approaches described above and effectively set upper and lower targets (thresholds) for both the cache hit rate (i.e. the probability that the data required is in the cache 210 when needed) and the preload success rate (i.e. a probability that preloaded data is used).

The cache hit rate is then measured over time. If the hit rate is higher than the selected upper threshold then the value of Tmmdg 330 is reduced so that the success rate falls. If the success rate is lower than the lower threshold (which must be less than or equal to the upper threshold) the value of Tmmdg 330 is increased by a suitable increment. When the success rate lies between the two thresholds the local machine 235 may be assumed to be receiving cache data in an efficient manner.

In this regard, data packet- 360 is shown as being transmitted at the latest time period 380 when the communication network conditions are ideal, and at an earlier time period 370 when the communication network conditions are, or are likely to be unreliable.

Additionally, the preload success rate is measured over time. If the preload success rate is higher than the upper threshold then Tmpl 350 is increased so that the success rate falls. If the success rate is lower than the lower threshold (which must be less than or equal to the upper threshold), Tmpl 350 is reduced by a suitable increment. When the preload success rate lies between the two thresholds the selection of data items and the timing of preload operations is being performed in an acceptable manner.

In the basic embodiment of the present invention, all preload types are given the same initial Ts 320, Tmmdg 330, and Tmpl 350 values, which are subsequently adjusted if the preload time or operating conditions change. In an enhanced embodiment of the present invention, each type of preload operation (scheduled event, foreseeable event, etc.) can be provided with a different initial, and/or subsequently adjusted, Ts 320, Tmmdg 330 and Tmpl 350 value.

In accordance with a yet further enhanced embodiment of the present invention, it is envisaged that events within the same knowledge type can be grouped into categories. For example, two or more categories may be distinguished within, say, a routine behaviour knowledge item type. Such categories could be, for example, those items whose uncertainty in the predicted time for being accessed by the cache user varies by less than thirty minutes and those whose uncertainty in the predicted time varies by more than thirty minutes. In this scenario, each category is provided with its own initial and subsequently adjusted Tmmdg 330 and Tmpl 350 timing parameter values. In a similar manner, instead of the categories being selected based on predicted time, the categories may be selected based on a priority rating applied to the respective knowledge items within the behaviour type.

Furthermore, for some knowledge types there may be uncertainty in the time at which data items are predicted to be required by the user. To improve the assurance of providing preloaded cache data to the user when he/she wishes it, a safety margin ‘Ts’ 320 is preferably introduced. The value of Ts will depend on the confidence in the prediction of the time the data item is needed: if the confidence is low, Ts will be set to a high value; if it is high then Ts will be set to a small value. Ts may be chosen and subsequently adjusted using the same techniques as apply to Tmmdg and Tmpl described previously.

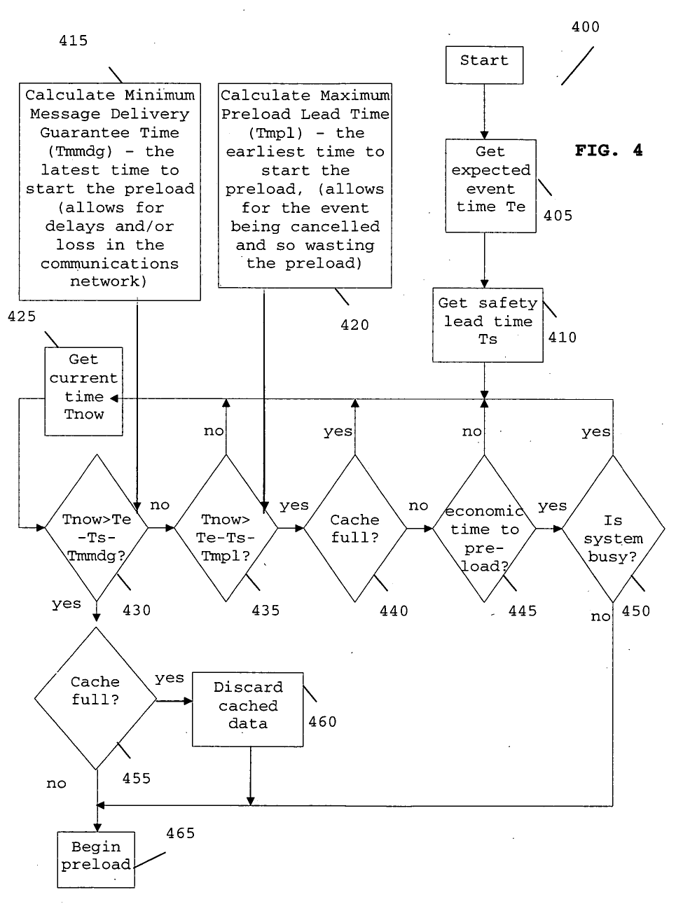

Referring now to FIG. 4, a flowchart 400 illustrates the preload operation of the preferred and a number of the enhanced embodiments of the present invention. The first task in the preferred process of preloading data to the cache is to obtain a value for Te 310, the predicted time of the event at which the preloaded data will be used, as shown instep 405. A number of example mechanisms for determining a timing of a predicted event are described above in Table 2. Such determinations can be made for a variety of knowledge items.

In accordance with an enhanced embodiment of the present invention, the inventors have appreciated that the prediction of an event time for a number of knowledge items will include an element of uncertainty. For example, knowledge items from the routine behaviour, predictable behaviour and foreseeable behaviour items in Table 1 may not be accessed at the same time of day by the user. For these types, a prediction of the uncertainty of these times is made, and an adaptation of the safety margin, Ts, is calculated in step 410. An ideal Ts 320 margin is calculated such that the preload functions ensure that the preload operation occurs early enough to take into account such unpredictability.

Table 2 shows preferred mechanisms for determining how Te and/or Ts can be calculated, for different knowledge item types.

TABLE 2
Calculating Te and Ts for different knowledge item types

| Knowledge | | |
|---|---|---|
| Item Type | Calculating Te | Calculating Ts |
| Meeting | Specified as part of the item | Zero |
| schedule/ | (e.g. meeting time). | |
| diary | | |
| Tasks | Either specified as part of | 1. Set manually; |
| | the task (e.g. due date) or | 2. Monitor prior |
| | through observing previous | occurrences and |
| | behaviour and predicting the | make prediction |
| | repetition pattern. | based on history |
| Routine | Through observing previous | 1. Set manually; |
| behaviour | behaviour and predicting the | 2. Monitor prior |
| | repetition pattern. | occurrences and |
| | | make prediction |
| | | based on history |
| Predictable | Triggered by another event | 1. Set manually; |
| behaviour | (e.g. download a list of | 2. Monitor prior |
| | items required to populate | occurrences and |
| | the next page in a series of | make prediction |
| | pages to be filled in by the | based on history |
| | user) | |
| Foreseeable | Triggered by another event, | 1. Set manually; |
| behabiour | likely with less certainty | 2. Monitor prior |
| | and an additional delay than | occurrences and |
| | predictable behaviour (e.g. a | make prediction |
| | service person may not need a | based on history |
| | parts list until recording a | |
| | job as being completed). | |

In order to perform the desired timing calculations, the respective preload function obtains a current time value, in step 425.

Clearly, if it is predicted that the user wishes to view the knowledge item imminently, an immediate preload is required, as shown in step time 430. In this regard, a value for Tmmdg is calculated, in step 415, as described above. Following the calculation of Tmmdg, a determination is preferably made as to whether the predicted timing of the event is within the minimum time period calculated for the safety time Ts added to the communication delay time Tmmdg. If it is, and the local preload function is initiating the preload operation, a determination is made as to whether the cache is full, in step 455. If the cache is not full, the preload operation commences in step 465. If the cache is full, or sufficiently full that the data to be preloaded into the cache will cause the cache to be full, the preload function initiates a discarding operation of the data within the cache, as in step 460. This discarding operation may be performed using any of the known techniques. After cache space has been made available, the preload operation may then commence, as shown in step 465.

A value for Tmpl is calculated, in step 420, as described above. If the determination in step 430 is that there is available time before the preload operation needs to start, i.e. the time of the event is further away than the minimum time period calculated for the safety time Ts and communication delay time Tmmdg, then a determination is made as to whether the time is close enough to the predicted time of the event to make it worthwhile beginning the preload operation, as shown in step 435. The determination in step 435 is preferably made in consideration of the fact that the event may be changed or deleted. Such a consideration may make the preload operation unnecessary.

The algorithm cycles through step 425, step 430 and step 435 until the preload operation is allowed, i.e. the predicted time to the event is determined as being within an acceptable window 340, at step 435. It is noteworthy that, in general, there will be a reasonable time window between the preload being allowed following step 435 and the preload being mandatory following step 430.

Once the preload function has determined the time to the predicted event is inside this window, a determination is made as to whether the cache has available capacity for receiving the preload data, in step 440. If there is not sufficient capacity within the cache in step 440, then the preload operation is delayed until there is sufficient capacity, by repeating steps 430, 435 and 440. This cycling operation only repeats until the minimum time period is reached in step 430.

The preferred mechanism for determining the fullness of the cache in step 440 is as follows. The rate of cache re-loads is measured, i.e. the frequency at which items that have been dropped from the cache 210 in FIG. 2 are subsequently reloaded. This measurement operation is performed over a suitable averaging period, likely to be a duration equal to several multiples of the average life of items in the cache 210. If the cache re-load rate is very low, for example less than a threshold of say 5%, then the cache 210 is deemed as being rarely full and is therefore available to be preloaded immediately. If the cache re-load rate is higher than this threshold, then the cache 210 is deemed too small for the data it is typically being asked to hold. In this case, preloading the data should be delayed as long as possible so as not to force other data items in the cache 210 to be discarded before the data has been used.

If a determination is made in step 440 that the cache has sufficient space to accept the preload data, then a determination is preferably made in step 445 as to whether the current time is the most economical time to preload the data. Advantageously, this provides the local machine with the opportunity to minimise costs by ensuring the preload operations are performed at a time that may incur reduced communications costs. Preferably, in step 445, the algorithm calculates whether there will a time within the acceptable window, i.e. before ‘Tnow-Te<Ts-Tmmdg’ is reached, when the preload operation over the communication network 155 will be less expensive. If such a determination is made in step 445, the preload function waits to initiate the preload operation, in step 465, until the less-expensive communication resource is available, by cycling through steps 430 to 445.

If, in step 445, a determination is made that it is an economical time to perform a preload operation, then a determination is preferably made as to whether the communications network 155 is busy in step 450, or at least that the network would not be overloaded by commencing the preload operation. It is envisaged that the preload function may take any measures necessary to reduce overload, depending upon the priority or urgency of the preload operation. Such measures are described later. If the communication network is determined as not being busy in step 450, the preload operation is commenced in step 465.

Those skilled in the art will immediately recognise that the respective steps can be effected in a variety of orders. Furthermore, several steps may be omitted or modified in their operation, depending on the importance of managing the size of the cache 210, the cost of the communication network 155 and the load on the communications network 155. In this regard, in some scenarios, it is within the contemplation of the invention that step 445 may be omitted, for example if there is no cost implication in using the communication resource at various times. Additionally, the local machine may be configured such that the cache is rarely, if ever, full. In-this scenario, the preferred algorithm may omit step 440. It is also envisaged that the determination in step 450 may be omitted, if the preload function is configured to force the preload operation ahead of other tasks being performed, for example if the preload operation was of a high (or highest) priority.

In many communications networks the cost of a specific transmission varies, depending on factors such as:
(i) The day or time of day;
(ii) The source and destination nodes of the communication link, for example their geographic location and/or the communication resources available at that location; or
(iii) The structure of the data message to be transferred, for example whether it is a single unfragmentable large block of data or several smaller blocks.

In the preferred embodiment of the present invention, the cost (charging) parameters of the communications network 155 are defined within one or both of the preload functions 255, 265. In this manner, the preload functions 255, 265 are able to use these cost parameters to calculate the most cost effective time to preload particular items of data. For example, the preload functions 255, 265 may use the preferred algorithm of FIG. 4 to calculate that there is a wide-enough window during which a specific piece of data could be preloaded where the window extends over two (or more) of these cost parameters. In this regard, the preload function 255, 265 in step 445 would select the most cost effective time during this window to initiate the preload operation.

In a further enhanced embodiment of the present invention, it is envisaged that multiple communications networks connect the local machine 235 and the host machine 240. Perhaps, as is often the case, some of the networks may only be available intermittently, for example due to time or location constraints. In this case, it is envisaged that in step 445 the preload functions can calculate the costs of the preload on each network within the allowed preload window and select the least expensive communication network to use, as well as performing the preload operation at the cheapest time.

Optionally, rather than the parameters of the communications networks 155 being defined within the preload functions 255, 265, it is envisaged that the preloaded data or cost (charging) information may be obtained from a remote server that the preload functions are able to access. A first example is where the communications network cost parameters may be stored on a server within another network (for example, the Internet). In this regard, the preload functions 255, 265 use communication links to this network to download the parameters on a regular basis. Alternatively, the cost parameters may be downloaded automatically, or on command from the server when a change in the parameters had been notified or detected.

It is envisaged that a second example would be where the communications network cost parameters could be stored in the data store 130, which could itself be updated using the method described above. The host preload function 265 and/or the local preload function 255 could then access the cost parameters from the data store. Alternatively, the host preload function 265 could download the parameters over the communications network 155 and store them in the cache 210, in which case the local preload function 255 would appear to be just another using application as far as the cache 210 was concerned.

In addition, or in the alternative, a further reason for preloading a cache in accordance with the preferred embodiment of the present invention is to preload- data ‘only’ when network costs are inexpensive rather than loading the data at the point it is required but when the. network costs are higher. In this regard, the cache preloading operation may be initiated based on the time or the location of the local machine 235. As an example, if either preload function 255, 265 predicted that during the morning peak time a user would require a certain piece of data, it could initiate a preload during the night, i.e. at an off-peak time. In this regard, the data would be preloaded purely because it can be preloaded at a minimum cost and would be available in the cache 210 the following morning when required.

As a yet further optional improvement, one or both of the preload functions 255, 265 may be configured to assess how busy the communications network 155, local machine 235 and/or the host machine 240 are.

The one or both preload functions 255, 265 may also schedule preload operations for times that provide a more acceptable impact on the performance of their respective machines. Preferably, the scheduling includes one or both of the following methods:
(i) Scheduling the entire preload operation for periods when the communication networks is not busy; and
(ii) Scheduling the preload operation to occur in blocks of time with intervals arranged between the blocks for other network users to use. In this manner, the preload operation avoids consuming a whole communication resource for a prolonged period but instead provides other network users access to the network while the preload operation is in progress.

It is also within the contemplation of the invention that. data may be preloaded for events that have no pre-requisite time associated with them. One example would be for data that is personally interesting to the user such as sports results. Even though the preload function is able to predict that the user will want to access the cached data, the preload function may not be able to predict when. For these knowledge items, it is preferable for the preload function to initiate the preload operation as soon as the data becomes available. The techniques described above, which may be used to delay the preload operation, can also be applied for events that have no pre-requisite time associated with them. However, this is at the risk of the data not being preloaded and immediately available when the user wants to use it.

More generally, it is -envisaged that the aforementioned preloading operations may be implemented in the respective host or local machines in any suitable manner.

For example, new apparatus may be added to a conventional machine, or alternatively existing parts of a conventional machine may be adapted, for example by reprogramming one or more processors therein. As such, the required implementation (or adaptation of existing local or host machine(s)) may be implemented in the form of processor-implementable instructions stored on a storage medium, such as a floppy disk, hard disk, PROM, RAM or any combination of these or other storage multimedia.

In the case of other network infrastructures, wireless or wireline, initiation of a preloading operation may be performed at any appropriate node such as any other appropriate type of server, database, gateway, etc. Alternatively, it is envisaged that the aforementioned preloading operations may be carried out by various components distributed at different locations or entities within any suitable network or system.

It is further envisaged that the applications that use caches in the context hereinbefore described, will often be ones in which a human user requests information from the data store (or serving application) 130. The application 105 will then preferably provide the opportunity to select or influence preloading functions by the user. For example, a user may be provided with a series of questions to answer, in order to provide an initial user-behaviour characteristic.

It will be understood that the data communication system described above, whereby a cache is preloaded with the data the user needs, provides at least the following advantages:
(i) The selected user-specific data is made available notwithstanding whether, for any reason, the communications network fails (i.e. the reliability of the application in the local machine is much increased);
(ii) The response to the user is shortened, as data that is more useful is locally stored in the cache. Therefore, the data does not need to be retrieved across the network;
(iii) By careful selection of the time that the preloaded data is scheduled to be loaded into the local cache, communication costs may be minimised by configuring downloads when the network capacity is low and communication resource costs are inexpensive.
(iv) The effects on the performance of the local machine, host machine and communications network are minimised.

Whilst the specific and preferred implementations of the embodiments of the present invention are described above, it is clear that one skilled in the art could readily apply variations and modifications of such inventive concepts.

Thus, an improved mechanism for preloading data objects to a cache has been described wherein the abovementioned disadvantages associated with prior art arrangements have been substantially alleviated.

We claim:

1. A method (400) of preloading data on a cache (210) in a local machine (235), wherein said cache is operably coupled to a data store (130) in a remote host machine (240), the method characterised by the steps of:
determining a user behaviour profile for said local machine (235);
predicting (405) a time for data to be required by a user;
retrieving data relating to said user behaviour profile from said data store (130) in response to a predicted time;
calculating a safety margin of time; and
preloading said retrieved data to said cache (210), at a time at or before said safety margin prior to said predicted preload time, such that said data is made available to a user of said cache when desired.

2. The method (400) of preloading data on a cache (210) according to claim 1, wherein said step of determining is performed by a preload function (255) in said local machine 235 operably coupled to said cache and/or a preload function (265) in a remote host machine (240) operably coupled to said data store (130).

3. The method (400) of preloading data on a cache (210) according to claim 2 further characterised by the step of:
predicting, by at least one preload function, a data type required by said cache user based on said determined user behaviour profile.

4. The method (400) of preloading data on a cache (210) according to claim 1 further characterised in that the step of predicting (405), is performed by said at least one preload function, and comprises predicting (405) an event time for said data type to be required by said user based on said determined user behaviour profile (210).

5. The method (400) of preloading data on a cache (210) according to claim 3, wherein said step of predicting includes one or more of the following steps:
predicting said event time based on said data type;
observing one or more previous user behaviour patterns; or
predicting said event time following a trigger on another event.

6. The method (400) of preloading data on a cache (210) according to claim 3 further characterised in that the step of predicting comprises predicting a preload time, by said at least one preload function (255, 265) based on said predicted data type.

7. The method (400) of preloading data on a cache (210) according to claim 6, wherein said predicted preload time is based on one or more of the following parameters:
(i) An estimate of a cache re-load rate;
(ii) An availability of a communications network resource (155);
(iii) A previously achieved cache reload rate;
(iv) A cost parameter of one or more available communications network resources, for example a resource at a location and/or at a time;

8. The method (400) of preloading data on a cache (210) according to claim 1 further characterised by the steps of:
determining (425) a current time; and
calculating a subsequent event or preload time therefrom.

9. The method (400) of preloading data on a cache (210) according to claim 1, wherein said step of calculating a safety margin includes the step of:
predicting (410) an uncertainty of an event time, for example based on said data type and/or prevailing network conditions.

10. The method (400) of preloading data on a cache (210) according to claim 1, wherein said safety margin is either set manually or is based on a monitoring of previous event occurrences.

11. The method (400) of preloading data on a cache (210) according to claim 1, wherein said event includes one or more of the following:
(i) A diarised event for said user;
(ii) A task to be performed by said user;
(iii) A personal interest identified for said user;
(iv) A routine behaviour pattern identified for said user;
(v) A predictable behaviour pattern identified for said user; or
(vi) A foreseeable behaviour pattern identified for said user.

12. The method (400) of preloading data on a cache (210) according to claim 1 further characterised by a step, prior to said step of preloading, of:
determining and implementing a timing margin (Tmmdg) (330) to allow for potential unavailability of said communications network (155) before commencing said step of preloading.

13. The method (400) of preloading data on a cache (210) according to claim 12 further characterised by the steps of:
calculating a safety margin of time; determining whether a predicted timing of an event is within a time period of less than or equal to the current time minus said safety margin and/or said timing margin; and
commencing (465) said step of preloading in response to a positive determination.

14. The method (400) of preloading data on a cache (210) according to claim 3, the method further characterised by an intermediate step of;
determining (455) whether said cache has capacity to store said data to be preloaded.

15. The method (400) of preloading data on a cache (210) according to claim 14 further characterised by a step, prior to said step of preloading, of:
determining (435) a preferred maximum time (Tmpl) (350) before said predicted event time when said step of preloading can commence.

16. The method (400) of preloading data on a cache (210) according to claim 1 further characterised by the step of:
adapting one or more timing parameters (330, 350) continuously or dynamically in response to a change in the communication network or user behaviour profile.

17. The method (400) of preloading data on a cache (210) according to claim 16 further characterised by the steps of:
applying one or more threshold values to said one or more timing parameters (330, 350) for:
determining an acceptable cache hit rate, and/or
determining a preload success rate, and
adapting said one or more timing parameters (330, 350) in response to said determination(s).

18. The method (400) of preloading data on a cache (210) according to claim 1 further characterised by the steps of:
grouping data types into categories based on, for example, one or more of the following: said data types, a priority of said data type, a predicted event time for said data to be preloaded; and
scheduling a preloading operation of data based on said grouping.

19. The method (400) of preloading data on a cache (210) according to claim 1 further characterised by the step of:
determining (440) whether said cache has available capacity for receiving the preload data prior to commencing said step of preloading.

20. The method (400) of preloading data on a cache (210) according to claim 19, wherein the step of determining whether said cache has available capacity includes measuring a rate of cache re-loads.

21. The method (400) of preloading data on a cache (210) according to claim 8 further characterised by the step of:
determining (445) whether the current time is an economical time to preload said data to said cache, and in response to a positive determination, preloading said data to said cache (210).

22. The method (400) of preloading data on a cache (210) according to claim 21, wherein the step of determining whether the current time is an economical time includes calculating whether a more economical time may be subsequently available within an acceptable preload window for said step of preloading.

23. The method (400) of preloading data on a cache (210) according to claim 21, the method further characterised by the step of:
downloading one or more cost parameters associated with one or more network resource(s) to said host machine (240) or said local machine (235) or a remote server accessible by said host machine (240) or said local machine (235), such that said determination of whether said current time is an economical time to preload said data to said cache (210) can be made.

24. The method (400) of preloading data on a cache (210) according to claim 1, wherein said step of preloading includes:
preloading said retrieved data in said cache (210), based on said user behaviour profile for said local machine (235), only when network costs are inexpensive, such that said data is made available to said cache user when desired at a substantially minimised cost.

25. The method (400) of preloading data on a cache (210) according to claim 1 further characterised by the step of:
determining (450) whether a communications network (155) to be used in said preloading step is busy or whether said communications network (155) would be overloaded when commencing the preload operation, and in response to a positive determination delaying said step of preloading said cache (210).

26. The method (400) of preloading data on a cache (210) according to claim 25, wherein, in response to determining that the communications network (155) is busy or would be overloaded, the method is further characterised by the steps of:
scheduling an entire preload operation for periods when the communication network is not busy; or
scheduling said step of preloading on a block-by-block basis that provides intervals between said blocks for other users to use said communications network (155).

27. A cache (210) preloaded in accordance with claim 1.

28. A local machine (235) characterised by a cache preload function (255) operably coupled to a cache (210) that is preloaded in accordance with claim 1.

29. A local machine (235) comprising:
a local communication unit (115) for operably coupling said local machine to a host machine (240) via a communication network (155); and
a cache (210) operably coupled to said local communication unit (115); the local machine (235) characterised by:
a preload function (255), operably coupled to said cache (210), for determining a user behaviour profile for said local machine (235), predicting a time for data to be required by a user; calculating a safety margin of time retrieving data relating to said user behaviour profile from said data store (130) in response to said predicted time, and preloading data on said cache (210) based on said user behaviour profile, at a time at or before said safety margin prior to said predicted preload time, such that said data is made available to said cache user when desired.

30. The local machine (235) according to claim 29, wherein said local machine (235) is a personal digital assistant configured to communicate over, for example, a General packet radio network wireless network to a remote host machine (240).

31. A host machine (240) comprising:
a host communication unit (120) for operably coupling said host machine (240) to a local machine (235) via a communication network (155); and
a data store (130), operably coupled to said host communication unit (120); the host machine (240) characterised by:
a preload function (265), operably coupled to said data store (130), for determining a user behaviour profile for said local machine (235), predicting a time for data to be required by a user, calculating a safety margin of time, retrieving data relating to said user behaviour profile from said data store (130) in response to a predicted time and preloading data from said data store (130) to a cache (210) on said local machine (235) based on said user behaviour profile, at a time at or before said safety margin prior to said predicted preload time, such that said data is made available to a user of said cache when desired.

32. A host machine (240) characterised by a data preload function (265) operably coupled to a data store (130), for performing the cache preload steps according to claim 1.

33. A communications system (200) adapted to support the method (400) of preloading data on a cache (210) in a local machine (235) according to claim 1.

34. A communications system (200) adapted to support a local machine (235) according to claim 29.

35. A communications system (200) adapted to support a local machine (235) according to claim 30.

36. A communications system (200) adapted to support a host machine (240) according to claim 31

37. A communications system (200) adapted to support a host machine (240) according to or claim 32.

38. A storage medium storing processor-implementable instructions for controlling a processor to carry out the method of claim 1.
